(19) United States
(12) Patent Application Publication
(10) Pub. No.: US 2014/0265810 A1
(43) Pub. Date: Sep. 18, 2014

(54) Solid-state light source using passive phase change cooling

(71) Applicants: William R. Livesay, San Diego, CA (US); Scott M. Zimmerman, Basking Ridge, NJ (US); Richard L. Ross, Del Mar, CA (US); Eduardo DeAnda, San Diego, CA (US)

(72) Inventors: William R. Livesay, San Diego, CA (US); Scott M. Zimmerman, Basking Ridge, NJ (US); Richard L. Ross, Del Mar, CA (US); Eduardo DeAnda, San Diego, CA (US)

(21) Appl. No.: 13/815,674

(22) Filed: Mar. 14, 2013

(51) Int. Cl. F21V 29/00

(52) U.S. Cl. CPC F21V 29/006
USPC 313/12

(57) ABSTRACT

A solid-state light source with light emitting diodes embedded in thermally conductive luminescent elements is cooled by immersion cooling via a phase change material (liquid or pool boiling). The thermally conductive translucent luminescent elements are arranged to confine the boiling to an inner tube with the condensed liquid on the output faces so as to provide a flicker free 360 degree output light source. At least one face of each LED is exposed directly to the fluid and the LED is unconstrained so as to provide optical emission with little to no wavelength shift as a function of drive current.

### REFERENCE TO PRIOR APPLICATION

This application is a continuation-in-part of and claims priority in part from U.S. patent application Ser. No. 13/506,015, filed 21 Mar. 2012 and entitled “SELF-COOLING SOLID-STATE EMITTERS,” which is herein incorporated by reference. The later application claimed priority, in turn, from U.S. provisional application Ser. No. 61/465,611, filed Mar. 21, 2011, which is also herein incorporated by reference.

This application is also related to U.S. patent application Ser. No. ______, filed 14 Mar. 2013, entitled “Self-Cooling, Magnetically Connected Fixtures for Large Area Directional and Isotropic Solid-State Lighting Panels” of which Scott M. Zimmerman is the first-named inventor, and to U.S. patent application Ser. No. ______, filed 14 Mar. 2013, entitled “Lightweight Self-Cooling Light Sources” of which Scott M. Zimmerman is the first-named inventor. Both of the aforementioned applications are to be filed concurrently with this application and are herein incorporated by reference.

This application is also a continuation-in-part of and claims priority in part from U.S. patent application Ser. No. 12/924,479, entitled “Solid-State Light Source”, which was filed concurrently with the aforementioned application Ser. No. 13/506,015 and which is herein incorporated by reference. application Ser. No. 12/924,479 was filed as a continuation-in-part of application Ser. No. 12/315,482 entitled “Solid-State Light Source,” which issued as U.S. Pat. No. 7,804,099, which patent document is also herein incorporated by reference.

### TECHNICAL FIELD

This invention relates to solid-state light sources incorporating light-emitting diodes (LEDs) and phosphor conversion LED light sources. Light-emitting diodes include inorganic light-emitting diodes and organic light-emitting diodes (OLEDs).

### BACKGROUND OF THE INVENTION

Unlike incandescent light bulbs which radiate their excess heat, light emitting diodes and light sources based on light emitting diodes require some form of heat sinking and cooling to remove the energy from the p-n junction of the LEDs which is not converted to optical radiation. Failure to cool the LED sufficiently can cause large inefficiencies. As the junction temperature of the LED rises, the conversion of input electrical watts to optical watts decreases. Ultimately the LED will fail if the junction temperature exceeds its operational maximum. To provide a means of connecting an LED or LEDs to an electrical source, it is typically mounted to a circuit board or substrate with printed interconnects. This LED/substrate combination (commonly referred to as a package) is then mounted or appended to a heat sink. Heat generated in the LED must pass through the intervening materials (e.g. package) to reach the heat sink. The thermal impedance created by these intervening materials can inhibit the performance of a high brightness solid-state light source. FIG. 1a shows a conventional LED package to illustrate the intervening materials between the LED and a heat sink. Typically, conventional solid-state light sources have an LED 102 or multiple LEDs mounted via solder or epoxy 103 to a substrate 104 that is attached via a thermal adhesive 105 to a heat sink 106. The thermal impedance R_{θ} is calculated by dividing the thickness of the intervening layer (adhesive 103 or substrate 104) by the product of the area of the LED 102 and the thermal conductivity of the intervening layer (adhesive or substrate). Since the area of the LED is quite small the thermal impedance R_{θ} (Rtheta) can be significant. As depicted in FIG. 1B the total thermal impedance R_{θt} from the LED to ambient is equal to the sum of the adhesive thermal impedance R_{θ-A} 107, the substrate thermal impedance R_{θ-S} 108, the thermal adhesive thermal impedance R_{θ-ta} 109 and the heat sink thermal impedance R_{θ-hs} 110. Also added to this is the equivalent thermal resistance of the heat sink to ambient air R_{θ-ha} 111. The sum of all of these thermal resistances R_{θ-total}=R_{θ-adhesive}+R_{θ-substrate}+R_{θ-ta}+R_{θ-hs}+R_{θ-ha} can seriously limit the efficiency and output performance of a high brightness LED light source.

In U.S. Pat. No. 7,285,445, there is described a means of producing a high intensity ultraviolet light source by forced liquid cooling of the LEDs. In this case, a pump is required to pump the water from the LEDs to a heat exchanger where it is cooled and pumped back to the LEDs. By doing this, the LEDs may be driven harder to reach optical output not attainable with conventional cooling methods. Also in the prior art are solid-state light sources, which are cooled by submersing in a pool of liquid. In this case, either the liquid (e.g. water) reservoir is large enough to cool the light source or some form of active circulation system is required. Also in the prior art are LED light sources with liquid filled envelopes or bulbs wherein a high thermal conductivity liquid is circulated by natural convective currents that transport heat from the LED to the outside envelope of the bulb or a heat sink surface inside the bulb. Generally, where the cooling liquid is actively circulated higher luminance values can be attained than passively cooled systems. Luminance is the number of lumens divided by the product of the area and solid angle of emission of the source. In the passive cooling case, only moderate high luminance values can be attained due to the limited thermal transfer capacities of passively circulated liquids. It would be desirable to have a solid-state light source capable of very high luminance values that did not require active (forced) circulation of the cooling liquid. In most cases active circulation of the liquid requires a mechanical pump or pumps that require electrical energy to operate. This requirement tends to diminish the attractiveness of the higher energy efficiency of solid-state lighting.

In U.S. Pat. No. 7,331,691, a means of attaining a high luminance light source with heat pipes is described. In this case, heat pipes are utilized to transfer the heat from the LEDs to multiple fins, which are cooled by natural convection. In the heat pipe, water or a working fluid is boiled and the phase change heat of vaporization removes large quantities of heat to the condenser end of the heat pipe. Although the use of conventional heat pipes can provide for a high luminance light source there is a thermal resistance between the LED and the working fluid inside heat pipe. Theoretically, phase change (liquid to vapor) cooling can have very high heat transfer rates or effective thermal conductivity. Whereas solid conductors commonly used as heat spreaders and heat sinks such as aluminum, copper, graphite and diamond have thermal conductivities ranging from 250 W/mK to 1,500 W/mK, heat pipes can have effective thermal conductivities that range from 5,000 W/mK to 200,000 W/mK. Heat pipes transfer heat from the heat source (evaporator) to the heat sink (condenser) over relatively long distances through the latent heat of vaporization of a working fluid (phase change from liquid to vapor). Heat pipes typically have three sections: an evaporator section (heat input/source), adiabatic (or transport) section and a condenser section (heat output/sink). The typical envelope for a heat pipe is made out of copper, which has a relatively high thermal conductivity. This is important because the outside of the heat pipe is placed in contact with the component to be cooled and all of the heat must be conducted through the copper wall to the working fluid. In most cases, the highest thermal resistance is right at the interface between the heat sink and the part (e.g. LED) to be cooled. This is because the thermal resistance or impedance (R_{θ}) as given above is the distance (d) the heat must travel divided by the product of the thermal conductivity (k) of the material and the effective cross-sectional area (Ao) through the material. In the case of an LED, the cross-sectional area in contact with the heat sink is very small. Due to the small area of attachment of the LED to the heat pipe, the actual thermal resistance can create a large difference in temperature between the LED and the working fluid. For example, an LED with a cross sectional area (Ao) of 1 square millimeter will have a thermal resistance through the wall of a thin (d=1 mm) copper pipe of approximately (1 mm)/(1 mm2×0.4 watt/meter-Kelvin)=2.5° C./watt. In practice however to provide an interconnect means the LED must first be attached to an intervening substrate which adds its thermal impedance. This results in a total thermal impedance of: R_{θ-total}=R_{θ-adhesive to LED}+R_{θ-substrate}+R_{θ-substrate adhesive}+R_{θ-copper}. In this case, the total thermal impedance between the LED and the working fluid of the heat pipe can be over 10° C./watt. Operating a high brightness LED at a high input current of one amp will require dissipating almost 3 watts of power to a heat sink. This will create a temperature difference of 30° C. between the LED and the working fluid. Therefore, even though the heat pipe can transfer the heat very effectively within the working fluid, the LED performance will suffer due to the large thermal impedance between the working fluid and the LED.

However, if somehow the intervening thermal impedances are eliminated and the LED(s) placed in direct contact with the working fluid, the thermal resistance can be as low as 0.2° C./watt to 0.005° C./watt. This can reduce the temperature difference between the LED and the working fluid from 6° C. (in the aforementioned case) to below 0.15° C./watt.

Therefore, it would be desirable to have a solid-state light source where the working fluid of a heat pipe is in intimate contact to the LEDs and wavelength conversion elements.

### SUMMARY OF THE INVENTION

A solid-state light source is capable of very high luminance and very high lumen per watt efficiency without requiring an active cooling system. The light source is cooled by phase change i.e. heat of vaporization (boiling) of a liquid in intimate contact with the LEDs of the light source. Further, the LEDs are embedded in a thermally conductive luminescent material that is also cooled by the phase change cooling (boiling) of the liquid. The liquid is circulated by liquid boiling out of an evaporative section where the LEDs are located and transported by vapor to a condenser section where the vapor cools back to liquid and by capillary action or gravity returned to the evaporator section. In a preferred embodiment of this invention, an inner channel is formed by multiple thermally conductive luminescent elements. Unique about this light source is that most of the boiling (phase change) occurs on the inside channel of the square tube formed by the thermally conductive luminescent elements. The liquid in the outside channel is in a liquid state (unboiled). This provides several unique functions: 1) There is no light fluctuation caused by boiling between the outside surfaces of the luminescent element and the outer transparent envelope containing the working fluid. 2) The inner and outer channels form separate transport paths (the inner channel for the vapor and the outer for the liquid). This minimizes entrainment of the vapor escaping from the boiling of the liquid on its transit path to the condenser section. This arrangement effectively forms a loop heat pipe, which is more efficient than a conventional heat pipe where the boiling and the liquid return path are contained in the same envelope. 3) The luminescent material, which forms the walls of the inner tube or channel is a ceramic phosphor with high thermal conductivity. This is important because in a white light source where blue LEDs are exciting a longer wavelength phosphor, the heat generated by Stokes shift in the material can be quite high and must be conducted away or cooled so that the phosphor does not thermally quench. 4) The thermally conductive luminescent wavelength conversion material also acts as a waveguide to spread out the blue light from the LED so that the wavelength conversion takes place over a volume of material—this effectively minimizes phosphor quenching due to high flux levels and it also reduces the heat flux at the liquid/vapor interface to the thermally conductive luminescent wavelength conversion material (or element).

Immersing the LED and the thermally conductive luminescent element in the working fluid eliminates the major thermal impedances of prior art methods of utilizing heat pipes for cooling of LEDs. Other advantages of this invention are enumerated in the detailed description of the various embodiments.

### BRIEF DESCRIPTION OF THE DRAWINGS

A more detailed understanding of the present invention, as well as other objects and advantages thereof not enumerated herein, will become apparent upon consideration of the following detailed description and accompanying drawings, wherein:

FIG. 1A shows a side view of a prior art conventionally mounted LED. FIG. 1B shows the thermal impedance of the prior art conventionally mounted LED of FIG. 1A.

FIG. 2 shows a side view of first embodiment of a solid-state light source using passive phase change cooling of the present invention.

FIG. 3 shows a cross-sectional view of a second embodiment of a solid-state light source using passive phase change cooling of the present invention, a four-sided light source enclosed in an outer transparent tube filled with liquid.

FIG. 4 shows a side view of a solid-state light source using passive phase change cooling of the present invention with reduced heat flux to the liquid/vapor interface.

FIG. 5A is a side view of wire bonds connecting the LEDs to electrical power of the present invention. FIG. 5B is a side view of beam leads connecting the LEDs to electrical power of the present invention. FIG. 5C is a side view of tab bonding connecting the LEDs to electrical power of the present invention.

FIG. 6A is a side view of the LEDs embedded into pockets in the thermally conductive luminescent element of the present invention. FIG. 6B is a side view of the LEDs mounted on the surface of the thermally conductive luminescent element of the present invention.

FIG. 7 shows a side view of the bottom extension on the internal four-sided tube depicted in FIG. 3.

FIG. 8A is a side view of the thermally conductive luminescent element is in the shape of a closed end tube of the present invention. FIG. 8B is a side view of the thermally conductive luminescent element is in the shape of a loop heat pipe of the present invention.

FIG. 9A is a side view of a luminescent cap of the present invention. FIG. 9B is a bottom view of a luminescent cap of FIG. 9A of the present invention.

FIG. 10A is a side view of a reflective luminescent cap of the present invention. FIG. 10B is a side view of a hemispherical luminescent cap of the present invention. FIG. 10C is a side view of a luminescent cap with a through hole pocket of the present invention.

FIG. 11 shows a side view of a pool boiling cooled solid-state light source containing one or more thermally conductive luminescent caps of the present invention.

FIG. 12 shows a side view of a projection source with a light source cooled via pool boiling of the present invention.

FIG. 13 shows a side view of a downlight with a light source cooled via pool boiling of the present invention.

FIG. 14 shows a side view of a white light source cooled via pool boiling of the present invention.

FIG. 15 shows a graph of reduced color coordinate shift in immersion cooled light sources due to unconstrained LED mounting of the present invention.

FIG. 16 shows a side view of a compact immersion cooled solid state light source with a recycling light cavity of the present invention.

### DETAILED DESCRIPTION OF THE DRAWINGS

FIG. 2 shows a first embodiment of a solid-state light source using passive phase change cooling of the present invention and the elimination of the intervening materials and thermal impedances between the LED and the working fluid of a phase change material (e.g. water, alcohol, etc.). An LED 112 is mounted to a thermally conductive ceramic luminescent element 114 (TCCLE) via a clear adhesive layer 113 (e.g. silicone, epoxy, glass frit, etc.). The index of refraction of this adhesive layer is selected to match or minimize the Fresnel losses between the LED and the TCCLE. With the exception of diamond, most transparent materials do not have high thermal conductivity. However, in this case it does not matter because the backside 115 of the LED is uncovered. The thermally conductive luminescent material or elements (TCCLE) as described in this invention can be made with different formulations. These are further described in the patent applications that have been incorporated by reference. One preferred embodiment is the TCCLE consisting primarily of Yttrium Alumina Garnet with a Cerium dopant and may also have other dopants to broaden the spectral output or adjust color temperature of the light source. It is important that the thermal conductivity of the luminescent material be sufficiently high to dissipate the heat generated by the Stokes shift throughout the TCCLE. Preferred is a thermal conductivity of greater than 10 watt/(meter-° K). More preferred is a thermal conductivity of greater than 20 watt/(meter-° K). As compared to the prior art, in this embodiment the substrate or package, upon which the LED is typically mounted, has been eliminated and the interconnect 116 to the LED is located directly on the thermally conductive luminescent element. This exposes at least one side 115 of the LED to the phase change working fluid. Therefore, the thermal impedance is minimized and the removal of heat from the LED is determined solely by the evaporative cooling rate of the phase change fluid in contact with the LED surface (as shown in the following figure).

FIG. 3 shows a second preferred embodiment of a solid-state light source using passive phase change cooling of the present invention shown in a cross-sectional view. Multiple TCCLEs 119 are arranged to form a four-sided box (in this view two sides are shown) with open bottom 121 and top 126 where the sides of the box are thermally conductive luminescent elements 120 (TCCLE). At least in one embodiment, this arrangement forms a square tube. This square tube is immersed or submerged in a pool of liquid 120 contained in an outer transparent tube 123. The fluid is filled to a level 122 just above the top 137 of the thermally conductive luminescent elements. This arrangement creates an inner channel 124 and outer channel 125 for the liquid. LEDs 130 are mounted or embedded in the inward facing surfaces 127 of the thermally conductive luminescent elements (sides) of the said square shaped tube. Cavities or pockets 128 are precut (via laser) into the thermally conductive luminescent elements such that the LEDs 130 will fit snugly into the pockets such that one face 132 of the LED will be exposed and in the same plane with the inside face 134 of the thermally conductive luminescent element. When voltage and current are applied to the LEDs the excess electrical energy, which is not converted to optical radiation is converted to heat energy. This heat energy must be removed by the LEDs or the LED will exceed its safe operating temperature. The heat generated by the LEDs raises the temperature of the liquid in the inner channel (inside of the box) until a boiling point (nucleate boiling) is reached. At this point, the liquid changes phase to vapor 136 (bubbles). The vapor then rises in the liquid until it escapes the liquid and is carried out through the top 126 of the inner channel formed by the thermally conductive luminescent elements. An extender tube 138 can optionally be appended to the box formed by the thermally conductive luminescent elements. The extender tube acts as a conduit to carry the vapor to the condenser section 140 of the heat pipe. The vapor continues to rise inside this extender tube until it exits 142 and impinges on the cooler surfaces 144 of the condenser section of the light source heat pipe. The inside surfaces 144 of the condenser section are roughened or porous to increase their surface area and act as a heat exchanger between the exterior cooling fins 149 of the heat pipe. The vapor condenses on these cooler surfaces back to a liquid 146 and returns via gravity or capillary action in a wick not shown along the outer channel (formed by the inner tube and outer tube) to the pool 120 of liquid toward the bottom of the outer tube. The pool of liquid also cools the outer surfaces 150 of the thermally conductive luminescent elements. Optionally, in one embodiment of the invention, the amount of heat that is allowed to escape to the outside surfaces of the thermally conductive luminescent elements is controlled. The reason for this is to ensure that boiling only occurs in the inner channel and no boiling occurs in the outer channel. If boiling occurs in the outer channel, the light emanating from the light source will fluctuate due to the differences in index of refraction between the vapor (air) bubbles and the liquid. Used for general illumination, this is not desirable. Therefore, a thin transparent thermally insulating layer or film 152 may be applied to the outer surfaces 150 of the thermally conductive luminescent elements to control the ratio of heat removed by the pool of liquid versus the heat removed by the evaporative phase change boiling on the inside of the tube.

It has been discovered that direct phase change cooling is the most effective means of cooling LEDs. There are no natural or man-made materials that approach the heat transfer capacities of a liquid in intimate contact to the LED undergoing phase change to a vapor. In tests on these sources interspersing a very high thermal conductive material (diamond, pyrolytic graphite, etc.) between the LED and the evaporating liquid resulted in lower operating efficiencies (lumens out versus power watts in). These intervening materials were interspersed to reduce the heat flux in contact with the liquid at the LED surface below the critical heat flux of the working fluid. Exceeding the critical heat flux causes film boiling (as opposed to nucleate boiling) and dry out of the LED surface. This can cause instantaneous failure of the LED because there is minimal heat transfer from the LED if no liquid is reaching its surface. It was found that interspersing solid heat spreaders does allow higher input power to be applied. However, the LED junction temperature increased significantly reducing the lumen per watt efficiency of the light source. Therefore, it is preferable to have the LED in direct contact with the working fluid.

There may be some situations where higher operating powers may be desired. In that case, an intervening material between the LED surface and the working fluid may be used to reduce the overall heat flux in contact with the fluid. Therefore, another embodiment of the invention utilizes a thermally conductive material interspersed between the LED and the working fluid.

Depicted in FIG. 4 is a section of the thermally conductive luminescent element 160 with LED 162 embedded into a pocket 164 of said element. Index matching adhesive or material 165 is between the LED 162 and the TCCLE 160. Attached to the backside of the LED is a solid heat spreading material 166 (e.g. diamond, pyrolytic graphite, aluminum nitride, alumina, etc.). The LED is soldered to the heat spreader 166 via solder pads 167. A thin conductive interconnect 169 on the heat spreader connects the LED to the interconnect 169 on the TCCLE. This, in turn, connects to adjacent LED 170 shown without a heat spreader. The thickness and area of the heat spreader 166 is adjusted such that the heat flux reaching the phase change fluid is reduced below the critical heat flux of the fluid. Particularly useful and preferred for this embodiment is the use of pyrolytic graphite, which has an asymmetrical thermal conductivity. This asymmetrical thermal conductivity can be utilized to spread the heat to a large area and to minimize a hotspot adjacent to the LED. Because of its very high thermal conductivity in only one axis, heat spreading may be accomplished with a thin layer of the material. This is important to keep the overall dimensions of the light source as small as possible. Minimizing the area of light emission maximizes the brightness or luminance of the light source. To obtain a light source that emits largely into a 360 degree solid angle requires at least a three sided and preferably a four sided square tube. There is a relationship between the cross-section of the inner channel formed by the thermally conductive luminescent elements and the amount of energy or heat that can be removed by the evaporating working fluid. Therefore, for higher output light sources requiring larger input power it is desirable to have as large of an inner channel as possible. However, the larger the mean diameter, of the formed square tube, the larger the area will be from which the light will be emitted. This reduces intrinsic luminance, also popularly referred to as brightness. Therefore, it is preferred that the sides of the square tube be kept as thin as possible.

The lower an LED's junction temperature, the more efficient it operates. It is desirable to keep the LED junction temperature as low as possible to maximize the energy efficiency of an LED light source. By selecting the working fluid and its intrinsic boiling point, one can optimize the performance of the phase change cooled light source by minimizing the LED junction temperature. The boiling point can be further reduced by pulling a partial vacuum on the envelope containing the fluid in the light source. In fact, the boiling point can be very precisely established using this method. Various working fluids may be used. For example, water, alcohol, water and alcohol, polymer fluids, hydroflouroether, Methyl nonafluorobutyl ether, Methyl nonafluoroisobutyl ether, Dow Corning OS-10, Hexamethyldisiloxane (HMDS), propylene glycol, ethylene glycol, segregated HEF, perfluorinated liquids, and other heat transfer fluids or phase change materials. By selecting the appropriate fluid, an operating temperature may be achieved without requiring a partial vacuum applied to the envelope.

For the preferred embodiment of this invention, depicted in FIG. 5 are various means of electrically connecting the LED or to a network of LEDs and subsequently to a power source. Electrical connection to the LEDs may be accomplished in a number of ways. With direct attached LEDs (e.g. Cree DA1000) both anode and cathode connection to the LED are brought out to the underside of the LED. In the embodiment of the invention utilizing an intervening substrate between the working fluid and the LED, it was shown that the LED can be attached to a printed circuit on the intervening substrate. The substrate (and printed circuit) may extend beyond the LED and contact the thermally conductive luminescent element. The thermally conductive luminescent element has a matching interconnect printed on its inward facing surface. In a more preferred embodiment, there is no intervening material or substrate between the LED and the working fluid. As depicted in FIG. 5A, wire bonds 180 are used to interconnect the LED 182 to the interconnect 184 printed on the thermally conductive luminescent element. Alternatively, as depicted in FIG. 5B, beam leads 186 may be used to interconnect the LED 188 to the interconnect 189 printed on the thermally conductive luminescent element. Alternatively as depicted in FIG. 5C, tab bonding 190 may be used to interconnect the LED 192 to the interconnect 194 printed on the thermally conductive luminescent element. The interconnect 184, 189 or 194 printed on the thermally conductive luminescent element may connect to other LEDs in a series or parallel network. Said printed circuit may then provide two electrical leads that are brought to a side where wires are attached. These wires can then be routed up through the inner channel of the tube (formed by the TCCLEs) to a feed-through (located in the condenser section) to connect to a power supply outside the enclosed heat pipe.

Two configurations for mounting the LEDs are depicted in FIGS. 6A and 6B. In one embodiment of the invention the LED(s) 200 are embedded into pockets 202 in the thermally conductive luminescent element 204. In another embodiment, they may be mounted on the surface of said elements. One of the advantages of embedding the LED(s) into the pockets is that there is better light coupling to the thermally conductive luminescent elements. Light coupled to the elements will waveguide within the elements increasing the phosphor conversion efficiency. Alternatively, as depicted in FIG. 6B mounting the LEDs 210 on the surface 212 of the TCCLEs 214 allows more surface area of the LEDs to be in contact with the working fluid. This will increase the phase change cooling of the LED. However, there will be less light coupled from the LED and therefore less light wave guided through the thermally conductive luminescent elements.

Having a small emitting area high brightness source allows the source to be readily projected via secondary optics onto the object or scene to be illuminated. Having a small source makes it easy to collimate, focus or manipulate light for various applications. It also simplifies the optics to perform these tasks. Further, with the emitting elements immersed in a high index liquid (working fluid) focusing of the source or manipulating its output distribution can be readily accomplished by shaping the outer glass envelope. Said light source can be combined with various reflector optics external to the light source tube to achieve a collimated light source with selected beam divergence from one degree to 90 degrees. These coupling optics may include: reflectors, diffusers, lenses, non-imaging elements, and micro-optic elements with or without additional wavelength conversion means.

As shown in the previous embodiments, the light source emits in a substantially 360-degree solid angle about its axis. However, there may be cases where it is desirable to have a light source that emits within a smaller solid angle. This can readily be realized by utilizing the optics described above to capture, reflect and focus the light emitted by the 360-degree light source. Alternatively, another embodiment of the invention could employ one emitting element, or two, or three with the remaining sides being reflective on the inside to maximize emission or output in the desired number of faces utilized. For example, instead of forming the inner tube with four TCCLEs, there may be a case where only one TCCLE is used with three glass or reflective substrates or substrates of other material to form a tube with only one emitting side. Alternatively, two opposing TCCLEs may be used with non-emitting sides closing off the other two sides. Alternatively, the TCCLEs may be used with only one side made of a non-luminescent material. This flexibility allows this light source to be used with virtually any type of general or specialized lighting application. It provides a means of making very efficient light sources customized to each application with appropriate additional optics.

In the previous embodiments, the concentric loop heat pipe light source is shown with the evaporator section below the condenser section of the heat pipe. The working fluid is circulated by boiling vapor rising up the inner tube and condensing and then gravity fed back to the evaporator section in the outer channel formed by the concentric tubes. With this configuration, the preferred orientation of the heat pipe is vertical or near vertical. If the heat pipe is oriented much past 45 degrees from vertical, it will suffer in performance. However, a near horizontal orientation may be accomplished by utilizing a wick structure in the outer channel to return the liquid from the condenser section via capillary action.

FIG. 7 depicts a further embodiment of the invention. An extension 300 is added below the LED light output (evaporator) section. This extends the inner tube 310 lower in the reservoir of the working fluid 312. If this extension is not present as shown in FIG. 7 the vapor (bubbles) 336 from the boiling occurring in the inside tube can escape 322 through the bottom opening of the tube 324. This is undesired because it can cause entrainment or impede the cooler (unboiled) fluid 326 from reaching the evaporator section and any bubbles 322 in the outside channel will cause fluctuations in the light emitted by the light source. This fluctuation is caused by the near unity index of refraction of the vapor bubbles compared to the near 1.5 index of refraction of the unboiled working fluid. The upper extension tube 338 and the lower extension tube 300 may be adjusted in length to enhance the natural convection current induced by the boiling and vapor leaving the evaporator and transported to the condenser on the inside channel of the inner tube. This improves the flow of cooled liquid to the LEDs and increases the critical heat flux at the LED surface.

Another embodiment of the invention is depicted in FIG. 8A. In this embodiment, the thermally conductive luminescent element is in the shape of a closed end tube 400. The LEDs 402 are mounted to the inside of the tube by a sleeve 404 with through hole openings 406 for the LED and an interconnect 408 is printed on the sleeve. The sleeve may be fabricated out of a multilayer flexible circuit. The advantages of forming the light source in this manner provides for a larger inner tube cross section, which will allow more heat to be removed, and it also eliminates any boiling on the output side of the ceramic luminescent material. However, it does require the condensed liquid to be returned in the same channel as the rising evaporated vapor. Therefore, a wick 410 may be used to return the liquid from the condenser to the evaporator. A ceramic thermally conductive luminescent tube may be fabricated by injection molding. Whereas it would appear difficult to assemble such a light source, it can be done quite readily. LEDs are tab bonded (using beam leads) to the flexible printed circuit. The flexible circuit can be a thin layer of polyimide or Mylar, etc. which is clad in copper (one side or two sides). An index matching transparent adhesive is coated on the output sides of the LED(s). The flexible circuit is then rolled into a tube and inserted into the ceramic thermally conductive luminescent tube. The LEDs are aligned and pressed into the pockets in the tube and the adhesive is cured.

Alternatively, as shown in FIG. 8B, a loop heat pipe is formed by returning the cooled liquid through an inner tube 420 connected to the condenser section 422. This eliminates the entrainment and wick required with the aforementioned method of this particular embodiment. Since the inner tube is returning liquid it can be smaller than the outer channel 424 where the boiling occurs. This helps to maximize the heat transfer. The condensing section may have a large collection area 426 for the condensing vapor and a radial channel 428 to the center tube. To enhance the transfer of heat to the outer fins 430 of the external heat sink the fins may extend 432 into the condensing section through sealed slots 434 in the outer enclosure 436 of the condenser.

FIG. 9A and FIG. 9B depicts luminescent cap 900 made out of a thermally conductive luminescent material as embodied in this invention. Ceramic, single crystal, polycrystalline, and inorganic/organic composites maybe used to form the luminescent cap. A preferred embodiment is based on a translucent or transparent matrix material including but not limited to Al203, ZnO, spinel, AlON, MgO, Y2O3, BN, diamond, or other inorganic matrix material with a thermal conductivity greater than 10 W/m/K into which luminescent material is dispersed. Single crystal, polycrystalline, ceramic and composite luminescent materials are disclosed. The luminescent cap 900 formed via sintering, laser melting, injection molding, dry pressing, high pressure forming and other mechanical and thermal forming means may be used to consolidate the materials. The luminescent caps 900 may be attached to direct attach LED die 908 via bonding layer 914 which may also contain additional luminescent elements. In this example a truncated pyramidal shaped direct attach LED die 908 having two eutectic solder contacts 910 and 906 is inserted into a pocket formed in luminescent cap 900. As such luminescent cap 900 and bonding layer 914 would be provided to the end user as a means of wavelength conversion of direct die attach LEDs. Most preferably, bonding layer 914 is a thermoplastic adhesive layer with a softening point below 250 degrees C., such that attachment and rework could be accomplished on direct attach die 908 which have already been soldered to an underlying submount. Typically eutectic solder temperatures are 300 to 325 degrees C. The ability to rework is not possible with existing conversion means which consist of silicones which contain luminescent powders adhered directly to the direct attach LED die 908. Optionally, additional bonding or interconnect means 904 and 912 can be used to remove heat from luminescent cap 900 and direct attach LED die 908. As an example, additional bonding or interconnect means 904 and 912 may consist of low temperature solder contacts that can be soldered to the submount.

FIGS. 10A, 10B, and 10C depict various shapes for the luminescent caps. The outer surface of the cap may be but not limited to hemispheres, cones, pyramids or flat tops.

FIG. 10A depicts a directive luminescent cap 1000 containing a pocket 1004 and reflective layer 1002. In this example, the light generated is reflected off reflective layer 1002 to provide some directivity to the source. In addition, the shape of luminescent cap 1000 and use of reflective layer 1002 may be used to more effectively couple light into waveguides for backlights and general illumination. Unlike conventional white light LED sources that typically have hemispherical lens, this configuration may be directly butted up against a waveguide with little to no losses.

FIG. 10B depicts a hemispherical shaped luminescent cap 1005 containing pocket 1006. While pockets for direct die attach LED is a preferred embodiment, the use of other LED die types such as vertical, epichip, flipchip, and lateral designs are possible. In this case, optional electrical interconnect means 1007 may be used to allow for interconnect between the embedded LED die in pocket 1006 and any underlying submount.

FIG. 10C depicts the use of luminescent cap 1008 with a through hole pocket 109. In some cases it is advantageous to allow at least a portion of light within the LED die to directly escape without passing through the luminescent cap 1008. This includes both light generated within the LED but also light generated within the luminescent cap 1008 as well. As an example, blue light 1010 from the LED die enters the luminescent cap 1008 where it is converted to yellow light 1014 isotropically. Because the emission of yellow light 1014 is isotropically emitted, a high percentage of the rays like ray 1012 go back into the LED die. By forming a luminescent cap 1008 with a through hole overall efficiency can be increased while still allowing for significant wavelength conversion.

FIG. 11 depicts a pool boiling cooled solid-state light source, which contains one or more thermally conductive luminescent caps 1126. The advantage of luminescent caps 1126 is reduced material cost while maintaining stability in the pool-boiling environment. As previously disclosed, the liquid provides the primary cooling mechanism for the LED and thermally conductive luminescent caps. Pool boiling has an effective thermal transfer rate several order of magnitude higher than even a diamond substrate. By directly exposing LED die 1128, wire bonds 1134 and luminescent assembly 1124 to the liquid and allowing boiling to occur the temperature of the light source can be maintained within a very narrow operational temperature range. This allow for very stable operation up to the film boiling point of the device. Using this approach, greater than 130 lumens/watt efficiencies can be realized with virtually zero color shift versus drive current for sources emitting over 4000 lumens. Color shift is predominately driven by temperature changes of the luminescent materials and LED die. The typically source area is 1 to 2 cm². The emission is pseudo isotropic or toroidal and very similar to tip reflector coated halogen or metal halide lamps used in automotive applications. This output distribution is very advantageous in reflector design. The lack of color shift is due the narrow operating temperature created by the liquid pool boiling cooling means. Unlike conventional cooling means, the thermal resistance between the LED 1128 and the liquid 1108 is essentially zero up to the film boiling point at which point dry out occurs. The use of optical and thermocouple means to sense the onset of film boiling is also included as an embodiment of this invention. In this example, external contacts 1102 and 1104 provide power via wires 1120 and 1118 which connect to luminescent assembly 1124 on interconnect layers 1132. Power is delivered to the LED die 1128 via wire bonds 1134. The LED die 1128 is bonded into luminescent cap 1126 using bonding layer 1136. Both the luminescent cap 1126 and bonding layer 1136 are part of luminescent assembly 1124. The liquid 1108 is contained in transparent vessel 1106 and cooling element 1100. Chimney elements 1122 and 1130 prevent the bubbles 1110 from causing flicker from the light generated. The elimination of bubble formation within the optical path emission is an important aspect of this invention. Bubbles 110 move towards the cooling element 1100 as shown by pathway 1112. Condensed liquid flows back to the light source via pathways 1114.

FIG. 12 depicts a projection lamp formed using this invention. In this case, the LED die 1208, 1212, and 1214 are formed into a cavity configuration whereby three sides of solid transparent cube 1209 contain LED die. The recycling cavity allows for very small etendue sources but also allows for efficient cooling of the LED die using pool boiling by exposing the contacts surfaces of LED die 1208, 1212, and 1214 directly to the liquid 1220. The use of the solid transparent cube 1209 attached to transparent envelope 1204 eliminates flicker caused by the pool boiling bubbles 1206. It is again an important aspect of this invention that flicker is eliminated by preventing the formation of bubbles within the emission path of the light source. Unlike conventional liquid cooled sources, operation at much higher power densities can be realized where pool boiling can be utilized. Without the phase change, liquid cooling heat transfer rates are orders of magnitude lower than with phase change. It should also be noted that direct contact between the heating surfaces and the liquid 1220 under pool boiling conditions is a novel aspect of this invention. As previously stated, the heat transfer rate for pool boiling is orders of magnitude higher than even diamond.

FIG. 13 depicts a downlight formed using this invention. A reflector 1306 surrounds the emitting end of source 1300 with the cooling fins project out of the top of the downlight. The emitter 1304 in this configuration resembles a box kite and emits an essentially toroidal intensity pattern that allows for virtually all the emission to impinge on reflector 1306. The design of this invention is especially advantageous for integration with parabolic, elliptical and spherical reflectors. The source preferentially emits a toroidal intensity pattern, which can be substantially encompassed by a deep reflector element. In this manner the majority of the solid angles emitted by the source can be effectively redirected as shown via ray 1310. This allows for efficient optical designs for applications such as downlights, wall washers, auto headlights and spotlights. A conventional halogen or metal halide auto headlight is typically coated with a reflector specifically designed to prevent any light from being emitted from the tip of the lamp. This forms a toroidal emission pattern very similar to the disclosed invention and allows for narrower far field beam patterns and the elimination of excess glare to oncoming cars. The disclosed invention can be used to form the desired toroidal beam pattern for auto headlight applications.

FIG. 14 depicts a stack that includes at least one LED chip 1418 and at least one wavelength conversion chip 1412 cooled via pool boiling utilizing direct contact with the optically transparent fluid 1420 within a sealed transparent envelope 1400. The optically transparent fluid 1420 can be either a gas or liquid depending on the power density to which the optically transparent fluid is exposed. The fluid can be either a single chemical element or a compound or can be a mixture of chemical elements or compounds. Example liquids include, but are not limited to, water, fluoro-carbon liquids and chloro-carbon liquids. Example gases include, but are not limited to, air, nitrogen and inert gases such as argon and helium. Most preferably, the optically transparent fluid 1420 is a liquid or mixture of liquids with a boiling point between 25 degrees C. and 100 degrees C. Power density on LED die 1418 is selected such that pool boiling occurs. As an example, 3M Novec 7200 has a boiling point of 62 degrees C. when LED die 1418 is driven at greater than 1 W/mm² pool boiling is observed at atmospheric pressures within the source. Bubbles 1406 transport to a cooling means (not shown) via pathway 1404 and return via pathway 1402. In this particular example, a through hole luminescent cap 1412 converts a portion of the light emitted by LED die 1418 while the remainder of the light emitted by LED die 1418 is emitted through the hole which is filled with silicone matrix 1414 which contains a red phosphor powder 1416. Again the optical emission is not exposed to bubbles 1406 which would create flicker.

FIG. 15 depicts the color coordinates of two different light sources as a function of drive current. 1500 represents the blackbody curve as depicted on the CIE color chart. 1504 shows the typical color coordinate shift for a typical solid-state light source as a function of drive levels. The color coordinates of solid-state light sources shift due to the spectral shifts of the LEDs and the wavelength conversion materials. As the drive levels increase the wavelengths emitted by the LEDs not only shift towards shorter wavelengths, the range of wavelengths expands slightly. The wavelength conversion material also changes as a function of drive levels. Both thermal and concentration quenching causes the wavelength conversion material to emit more or less photons. In addition, because the wavelength conversion material is excited by the LEDs, any change either spectrally or intensity by the LEDs changes the amount of photons emitted by the wavelength conversion material. There is still much debate regarding the exact cause of the spectral shift and “droop” in solid-state LEDs. It appears however that the anisotropic and piezoelectric nature of nitride based LEDs is a root cause of these shifts. Whatever the cause, the inventions disclosed can be used to dramatically reduce the color coordinate shift as a function of drive levels. 1502 is a typical color coordinate shift for the light sources disclosed in this invention. Both 1504 and 1502 are the color coordinate shifts for the same range of drive conditions. As an example, direct attach LED die are soldered to submount and drive between 50ma and 300 ma. Using a CeYag ceramic wavelength conversion element greater than 100K, color shift is measured. Using the same direct attach LEDs and wavelength conversion materials, the associated color shift is under 40K. In both cases, liquid immersion cooling was used to negate other thermal effects. It is proposed that the reduced spectral shift is due to the unconstrained nature of the LEDs in the disclosed invention. The LEDs in the mounting configuration disclosed above (e.g. FIG. 9, FIGS. 5A, 5B and 5C) are free to expand and contract and thereby have lower internal stresses than the conventionally mounted LEDs which a soldered onto a rigid submount. For example, the index matching gel or adhesive 914 shown in FIG. 9 may be compliant and allows for expansion and contraction of the LED. The electrical interconnect methods 180, 186, and 190 shown in FIGS. 5A,B and C allow for expansion and contraction as the interconnects are thin and flexible. The disclosed mounting configuration therefore negates the need the lower efficiency non-polar growth plane based LEDs as disclosed in the literature.

FIG. 16 depicts a compact immersion cooled solid state light source with a recycling light cavity. The solid cavity 1708 is used to mount LEDs 1710 which may be direct-attach die 1710. The solid cavity 1708 may be glass or a transparent thermally conductive material (e.g. diamond, Cubic Zirconium, etc.). The LEDs 1710 can be red, green, blue, cyan, or yellow emitting LEDs. Alternatively the solid cavity 1708 may be a thermally conductive luminescent element and the LEDs blue emitting. The LEDs are mounted and optically coupled to the solid cavity via a compliant and transparent index matching gel or adhesive 1720. This configuration is preferred because it allows for the LED 1710 to be unconstrained which in turn leads to lower color shift and higher efficiency due to reduced strain within the LEDs 1710. Interconnects 1712 and 1716 can be used to connect the LEDs 1710 with bonding pads 1706 and external contacts 1704. Shown are wire bond interconnects however other compliant interconnects may be used such as flex circuit, tabs, etc. Optionally a wicking structure 1702 may be used to return the condensed liquid 1714 the exposed surface of the LEDs. A typical wicking structure 1702 would be glass beads, alumina powder or other high thermal conductivity dielectric porous material. The optional wick structure 1702 would be used to return the condensed cooling liquid 1714 back to the LEDs 1710 by capillary action. The heat from the LEDs then would turn the cooling liquid 1714 to a gas which is condensed using the colder surface of the containment 1700. Alternately, a pulsating heat pipe configuration may be used to move the heat from LED 1710 to the condensing section of containment 1700. The LEDs may be pulsed with a duty cycle to cause a circulation of the fluid from one side of the cavity to the other with the condenser situated in between. Alternatively, the recycling light cavity may be hollow without a solid core. The LEDs would be formed into a sealed box like structure with the adhesive between them sealing the gaps between the LEDS. A reflective aperture 1722 may be positioned on the output side of the recycling light cavity whose opening would then define the etendue of the light source. Optionally a solid glass optical taper may be used as the recycling light cavity with the LEDs mounted directly to it. This can provide both optical mixing and collimation of the light emitted by the light source.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A solid-state light source utilizing phase change cooling, comprising:
at least one thermally conductive luminescent element;
at least one light emitting diode (LED) connectable to an external power source;
an outer envelope enclosing the at least one thermally conductive luminescent element and the at least one LED, the outer envelope being transparent over at least part of its surface to allow emission of light; and
a quantity of cooling fluid, of which at least a substantial portion is enclosed within the outer envelope;
wherein the outer envelope encloses an evaporator section in which the cooling fluid is transformed from a liquid phase to a gas phase by heat generated by the at least one LED and the at least one thermally conductive luminescent element, thereby removing heat from these elements by phase change cooling;
and wherein the outer envelope also encloses a condenser section from which heat is removed and in which the cooling fluid is transformed from its gas phase back to its liquid phase, for recirculation back to the evaporator section.

2. The solid-state light source of claim 1, and further comprising a heat sink thermally coupled to the condenser section, to facilitate heat removal from the light source.

3. The solid-state light source of claim 1, and further comprising:
an inner tube enclosed within the outer envelope;
wherein the inner tube provides an inner channel and defines one boundary of an outer channel formed between the inner tube and the outer envelope, whereby the inner channel provides a volumetric space for boiling of the fluid in its liquid phase and for transport of the fluid as a vapor to the condenser section, and whereby the vapor is cooled and condensed to liquid in the condenser section and returned via the outer channel, to form a reservoir of liquid in the outer in the outer envelope.

4. The solid-state light source of claim 1 wherein the at least one LED is a plurality of LEDs and the thermally conductive luminescent material contains an electrically conductive printed circuit to interconnect the LEDs.

5. The solid-state light source of claim 3 wherein:
the at least one thermally conductive luminescent elements is a plurality of such elements arranged to form the inner tube; and
the at least one LED includes at least one LED for each of the thermally conductive luminescent elements, the LEDs being mounted on inner faces of the thermally conductive luminescent elements.

6. The solid-state light source of claim 5 wherein the plurality of thermally conductive luminescent elements are arranged to form the inner tube with a cross-sectional shape of a polygon having at least three sides.

7. The solid-state light source of claim 5 wherein the LEDs are embedded in shape-conforming pockets in the thermally conductive luminescent elements.

8. The solid-state light source of claim 7 wherein at least one face of each of the LEDs is exposed to the cooling fluid in the evaporator section where boiling occurs.

9. The solid-state light source of claim 8 wherein each of the thermally conductive luminescent elements includes an electrical interconnect and the LEDs are connected to the interconnects via wire bonds or beam leads or tab bonding, to maximize exposure of each LED to the cooling fluid.

10. The solid-state light source of claim 6, wherein the exposed face of each of the LEDs is covered with a thin layer of heat spreading material

11. The solid-state light source of claim 5, and further comprising an extender tube appended to the inner tube formed by the multiple thermally conductive luminescent elements and extending into the reservoir of liquid, whereby the extender tube helps to prevent vapor from the evaporator section from entering the outer channel.

12. The solid-state light source of claim 5, and further comprising an extender tube appended to the inner tube and extending into the condenser section, whereby the extender tube enhances separation liquid-phase and gas-phase components of the cooling fluid in the condenser section.

13. The solid-state light source of claim 5, and further comprising a partially thermally insulating layer added to outside faces of the thermally conductive luminescent elements, whereby heating of the cooling fluid is confined largely to the inner channel.

14. The solid-state light source of claim 1, wherein the heat sink has cooling fins extending externally from and internally into the condenser section.

15. The solid-state light source of claim 1, wherein the outer envelope is of a thermally conductive luminescent material

16. The solid-state light source of claim 15, wherein the outer envelope includes a layer of wicking material affixed to the inner face of the outer envelope, to facilitate recirculation of the cooling fluid in its liquid phase.

17. The solid-state light source of claim 1, wherein the at least one LED is embedded in the thermally conductive luminescent element and wherein the thermally conductive luminescent element takes the form of a thermally conductive luminescent cap largely conforming to light-emitting surfaces of the LED and leaving one face of the LED exposed to the cooling fluid.

18. The solid-state light source of claim 17, wherein the thermally conductive luminescent cap is optically bonded to the LED.

19. The solid-state light source of claim 17, wherein said thermally conductive luminescent cap is optically coupled to an index-matching medium between the cap and the LED.

20. The solid-state light source of claim 17, wherein the LED has anode and cathode connections located on the exposed face of the LED.

21. The solid-state light source of claim 17, wherein the thermally conductive luminescent cap has output surfaces presenting a generally hemispherical surface.

22. The solid-state light source of claim 17, wherein the thermally conductive luminescent cap has output surfaces shaped to form a lens shaped to direct emitted light in a preferred way.

23. The solid-state light source of claim 17, wherein at least one face of the thermally conductive luminescent cap is reflective.

24. The solid-state light source of claim 1, wherein the at least one thermally conductive luminescent element has a through hole directly adjacent to the at least one LED.

25. The solid-state light source of claim 1, and further comprising reflective or refractive optics to redirect the light emitted

26. The solid-state light source of claim 1, and further comprising a color correcting phosphor distributed between the at least one LED and the at least one thermally conductive luminescent element.

27. A solid-state light source utilizing phase change cooling, comprising:
an outer envelope;
a tube having two open ends and contained within the outer envelope, wherein the tube forms an inner channel and, together with the outer envelope, forms a generally annular outer channel;
at least one light-emitting diode (LED);
at least one thermally conductive luminescent element, wherein the at least LED is partially embedded in the at least one thermally conductive luminescent element to form at least one light emitting structure that emits light largely from one side and heat largely from an opposite side of the structure, and wherein the at least one light emitting structure forms part of the tube and is positioned to emit heat in an inward direction into the tube and light in an outward direction from the tube; and
a quantity of cooling fluid enclosed within the outer envelope;
wherein the outer envelope encloses an evaporator section in which the cooling fluid is transformed, by boiling, from a liquid phase to a gas phase by heat transmitted into the tube by the at least one LED and the at least one thermally conductive luminescent element, thereby removing heat from these elements by phase change cooling;
and wherein the outer envelope also encloses a condenser section into which cooling fluid in its gas phase is transported through the inner channel, and from which cooling fluid in its liquid phase is transmitted through the outer channel to recirculate the cooling fluid
and whereby boiling of the cooling fluid in the evaporator section takes place largely in the inner channel, to minimize any optical distortion caused by boiling in the outer channel.

28. The solid-state light source of claim 27, wherein:
the tube and the outer envelope are oriented vertically, with the condenser section above the evaporator section;
cooling fluid in its liquid phase accumulates in and below the evaporator section;
cooling fluid in its gas phase rises through the inner chamber to the condenser channel; and
cooling fluid in its liquid phase returns from the condenser channel to the evaporator section through the outer channel.

29. The solid-stated light source of claim 27, wherein:
the light source is a projection light source; and
the at least one LED includes multiple LEDs arranged to form a light recycling cavity.
